(19) United States
(12) Patent Application Publication
(10) Pub. No.: US 2026/0287731 A1
(43) Pub. Date: Sep. 24, 2026

(54) METHOD FOR DETECTING GESTURES BASED ON A PULSED RADIOFREQUENCY SIGNAL

(71) Applicant: Vitesco Technologies GmbH, Munich (DE)

(72) Inventors: Maxime RATEAU, Toulouse (FR); Mohamed ELKAIROUH, Toulouse (FR); Maxime ROSANO, Toulouse (FR)

(73) Assignee: Vitesco Technologies GmbH, Munich (DE)

(21) Appl. No.: 19/572,310

(22) Filed: Mar. 19, 2026

(30) Foreign Application Priority Data
Mar. 20, 2025 (FR) 2502860

(51) Int. Cl. G01S 13/88; E05B 85/10; E05F 15/73; G01S 13/02; G01S 13/58; G05B 13/02; H04B 1/7163

(52) U.S. Cl. CPC G01S 13/88; E05B 85/107; E05F 15/73; G01S 13/0209; G01S 13/58; G05B 13/027; H04B 1/7163; E05Y 2900/531; E05Y 2900/546

(57) ABSTRACT

A method for detecting gestures based on a pulsed radiofrequency signal arising from a reflection from a moving target. The method can include obtaining an input datum chosen from at least one of the following types: an in-phase component I of the signal, a quadrature component Q of the signal, a phase of the signal and a derivative of the phase of the signal, corresponding to at least a portion of the signal resulting from a reflection from the target at a distance tapₖ. The method can further include determining, based on said input datum and using a classifier, a classification of the gesture according to the intentional or unintentional nature of the gesture.

### CROSS REFERENCE TO RELATED APPLICATIONS

This application claims the benefit of French Application No. FR2502860 filed on Mar. 20, 2025, which is incorporated by reference as if fully set forth.

### TECHNICAL FIELD

The present disclosure relates to the field of processing pulsed radiofrequency signals for gesture detection purposes.

### BACKGROUND

The field of ultra-wideband (UWB) radar sensors concerns detection and localization technology using wideband radiofrequency signals. A wideband radiofrequency signal is an electromagnetic signal comprising a carrier with a frequency of between 3 kHz and 300 GHz, for example, but most often between 5 GHz and 30 GHz.

UWB radar sensors emit short, broad-spectrum radiofrequency pulses, enabling high temporal resolution and the ability to penetrate through various materials.

These sensors are commonly used in automotive systems for gesture recognition, vehicle access and other functionalities that require accurate detection and measurement of the position of objects or movements.

UWB radar sensors capture signals reflected by objects at various distances, which are then processed to identify specific gestures. In particular, these systems are used to detect specific movements, such as kicks, in order to trigger automatic actions such as opening the trunk of a vehicle. Applications of this technology include hands-free vehicle access, security and surveillance, along with other gesture recognition-based control systems.

For example, kick sensors based on UWB radars are designed to detect specific movements of the foot under the rear bumper of the vehicle, thus triggering opening or closing of the trunk. This is a form of hands-free interaction designed for convenience and ease of use.

The purpose of a kick sensor is to allow the user to access the loading area of the vehicle without having to put down what they are carrying or physically interact with the automobile, such as when their hands are full with grocery bags.

A system responsible for detecting and isolating a gesture is already known. In particular, the start and end of a gesture may be determined by analyzing variations in the phase shift between an in-phase component and a quadrature component of the UWB signal generated by the sensor. According to one known example, the gesture is divided into three main phases: approach, stop and withdrawal. The approach phase starts when the phase shift is positive and stable, marking the start of the gesture. The stop phase is identified by a decrease in the phase shift toward a strongly negative value. The withdrawal phase, characterized by a negative and stable phase shift, signals the end of the gesture. A signal processing algorithm may be used to determine these three time windows.

Although kick sensors may be convenient and may provide hands-free access, they also have certain drawbacks, particularly in terms of sensitivity. Indeed, the algorithms that are used often make the systems highly sensitive, which may cause instances of opening without any intentional gesture being made by a user. Indeed, these systems should be capable of distinguishing between intentional gestures and unintentional gestures in order to avoid false activations. For example, the system should open the trunk when a user performs an intentional kick, but should not react to unintentional movements such as animals passing under the vehicle or walking movements.

Moreover, these algorithms comprise complex data processing steps, in particular in order to extract the relevant features from the acquired signals. This complexity is also a brake on an accurate system that distinguishes between intentional and unintentional gestures.

There is therefore a need for a simplified method that is more reliable in terms of its detection of movements and is capable in particular of identifying the intentional or unintentional nature of a gesture.

### SUMMARY OF THE INVENTION

To this end, what is proposed is a method for detecting gestures based on a pulsed radiofrequency signal arising from a reflection from a moving target, comprising the following steps:

a) Obtaining an input datum chosen from at least one of the following types: an in-phase component I of the signal, a quadrature component Q of the signal, a phase of the signal and a derivative of the phase of the signal, corresponding to at least a portion of the signal resulting from a reflection from the target at a distance tapₖ.

b) Determining, based on said input datum and using a classifier, a classification of the gesture according to the intentional or unintentional nature of the gesture.

A pulsed radiofrequency signal, for example an ultra-wideband (UWB) signal, is a type of radio signal transmitted in the form of short repeated pulses. These signals are used for various applications, in particular in radar systems, in which they make it possible to measure the distance and features of objects by analyzing the reflections of pulses from these objects.

It is possible to represent a pulsed radiofrequency signal S in an orthonormal reference system (O,\vec{ι},\vec{q}) comprising a point O as origin, \vec{ι} as abscissa vector and \vec{q} as ordinate vector.

In the orthonormal reference system (O,\vec{ι},\vec{q}), the signal S is a complex number decomposed into the sum of an in-phase component I (real component along \vec{ι}) and a quadrature component Q (imaginary component along \vec{q}), such that the signal S is defined by the following equation:

$$S = I + iQ \qquad [ Math . 1 ]$$

The phase φ of the signal S is equal to its argument:

$$φ = Arg ( S ) \qquad [ Math . 2 ]$$

The return signal S resulting from a reflection from a target may be sampled into multiple signals Sₖ, in ascending order of distance from the target, thus defining taps. A tap is the distance between the points of origin of two successive signals Sₖ for one and the same pulse. In other words, a tap is the distance between the reflection points of the outward signal generating return signals Sₖ and Sₖ₊₁ received successively by the transceiver. The value of tapₖ is the distance between the transceiver and the reflection point of the outward signal generating the return signal Sₖ. A tap may for example represent a distance of 15 cm.

It is thus possible to obtain, for each tap, an in-phase component, a quadrature component and the phase of the portion of the reflected signal in question. For example, it is possible to use Iₖ, Qₖ and φₖ, respectively, to denote the in-phase and quadrature components and the phase of the portion of the signal Sₖ resulting from a reflection from a target at a distance tapₖ.

In other words, during step a), the method proposes to obtain an input datum by selecting at least a portion of the signal from Iₖ, Qₖ, φₖ and \dot{φ}ₖ (the derivative of the phase) on at least one tap, that is to say resulting from a reflection from the target located at a distance tapₖ. For example, the input datum may consist of the in-phase component, the quadrature component, the phase and the derivative of the phase for the n first taps. In other words, the input datum might consist of the signal portions I₁, I₂, . . . , Iₙ, Q₁, Q₂, . . . , Qₙ, φ₁, φ₂, . . . , φₙ and \dot{φ}₁, \dot{φ}₂, . . . , \dot{φ}ₙ. In one preferred embodiment, the input datum is composed of 12 signal portions chosen from the above list.

The choice of the signal portions to be obtained to constitute the input datum may be predetermined.

Moreover, the data may be “int8”-quantized, that is to say quantized by signed integers and not floating-point numbers. The size of the model may thus be greatly reduced and requires less computing power. This type of quantization is particularly advantageous in the case of embedded systems.

A classifier is an algorithm or model used in machine learning to assign labels or categories to input data based on their features. In the context of gesture detection based on pulsed radiofrequency signals, a classifier may be used to distinguish between intentional and unintentional gestures.

Intentional gestures are deliberate movements made by a user with the aim of triggering a specific action, such as for example opening the trunk of a vehicle by kicking under the rear bumper. On the contrary, unintentional gestures are accidental or unintentional movements, such as those caused by animals or passersby, which must not cause said specific action.

The method thus uses rich and varied information for more accurate analysis. This approach makes it possible to capture fine movement details, thus improving gesture classification accuracy. In addition, by using a classifier, the method makes it possible to effectively distinguish between intentional and unintentional gestures, thus reducing false activations and improving the reliability of the system. For example, in the context of a vehicle, this makes it possible to open the trunk only in response to an intended kick, while ignoring unintended movements such as those made by animals or passersby.

The classifier may be a convolutional neural network.

Using a convolutional neural network (CNN) as a classifier makes it possible to automatically extract relevant features from the input data without requiring a complex input data engineering step. Unlike traditional methods that rely on manual feature extraction, the CNN processes raw signals directly, thereby simplifying the algorithm development process and improving classification accuracy. In addition, the convolutional layers of the CNN are capable of capturing local patterns and temporal dependencies in the data, thereby enabling better distinction between intentional and unintentional gestures. For example, successive convolutional and pooling layers make it possible to reduce the dimensionality of the data while still retaining the most significant features, thereby improving the robustness and efficiency of the model.

In particular, the CNN may comprise at least one convolutional layer, preferably two convolutional layers. For example, a first convolutional layer may comprise 48 filters, each having a kernel of size 4 and a convolution pitch of 3. Such a layer may make it possible to extract local features from the input datum. For example, a second convolutional layer may comprise 30 filters, each having a kernel of size 6 and a convolution pitch of 2. Such a layer may make it possible to capture more complex features by using a larger kernel and a smaller number of filters.

After the convolution operations, a non-linear activation function, such as the rectified linear unit (ReLU) correction, may be applied to the results obtained so as to introduce a non-linearity and allow the model to learn more complex representations.

A pooling layer may be placed after the convolutional and activation layers. Such a layer, for example a max-pooling layer, makes it possible to carry out subsampling of the data in order to reduce dimensionality without modifying the important features. This therefore makes it possible to reduce the number of parameters and calculations in the network and to prevent overfitting.

A flatten layer may be used in the CNN at the output of the convolutional and pooling layers. The flatten layer makes it possible to convert the multidimensional output of the convolutional and pooling layers into a one-dimensional vector, thereby allowing it to be introduced for example into fully connected layers.

The CNN may comprise fully connected layers (dense layers), for example at the output of a flatten layer. In particular, two fully connected layers may be used to combine the features extracted by the previous layers and carry out the final classification. For example, a first layer may comprise 11 neurons and the second layer may comprise one neuron. The first layer may use a ReLU activation function, while the output layer may use a sigmoid activation function to produce a probability score for the binary classification. Specifically, the sigmoid function may make it possible to transform the outputs of the fully connected layers into real numbers between 0 and 1, thus defining a classifier. The gesture may thus then be classified for example as being unintentional if the result is less than a predetermined threshold (for example 0.5), and as intentional otherwise.

This specific architecture makes it possible to achieve better gesture classification accuracy compared to the existing technique, and therefore to effectively distinguish between intentional gestures and unintentional gestures, in particular reducing false activations, while still being able to be implemented in an embedded system. This configuration is nevertheless one possible example of a CNN, but other architectures are possible.

The method may furthermore comprise, before step b), a step of normalizing the input data and/or standardizing the input data. Normalization consists in scaling the data so that they are within a specific range, generally between 0 and 1 or between −1 and 1. For example, for an input x, a normalization x′ of x may be expressed

$${x}^{′} = \frac{x - {x}_{min}}{{x}_{max} - {x}_{min}} ,$$

where xₘᵢₙ
and xₘₐₓ are the minimum and maximum values taken by x, respectively. Standardization consists in transforming the data so that they have a mean of 0 and a standard deviation of 1. For example, for an input x, a standardization x′ of x may be expressed

$${x}^{′} = \frac{x - μ ( x )}{σ ( x )} ,$$

where μ(x) is the mean of x and σ(x) is the standard deviation of x. These steps make it possible to transform raw data to a common scale, thus preventing some data from dominating others because of their larger values.

The method may furthermore comprise, before step b), a step of centering the input data. Centering consists in identifying a reference point in the data sequence, such as the maximum of an amplitude or a change in direction, and in aligning this point with the center of the sequence. For example, the phase maximum of the signal may be identified as the central point of the gesture. Indeed, in the case of a kick, this point represents the change in direction at the apex of the kick.

The method may furthermore comprise, after the centering step, a step of equalizing the length of the input data. A desired length, for example 400 points, may be predefined, and the length of the data may be equalized by padding or truncation. Padding consists in adding values (generally zeros) to the end or start of shorter sequences so as to bring them to the predefined length. Truncation consists in cutting longer sequences so as to bring them to the predefined length.

Step a) may comprise obtaining a sequence of points obtained during a time interval, said points being representative of the evolution of said input datum during the time interval. For example, the input data may comprise 400 points, representing the evolution of the signal over 800 ms.

Said target may be a part of the body of a user.

The pulsed radiofrequency signal may be an ultra-wideband (UWB) signal.

The input data may be int8-quantized, that is to say quantized by signed integers.

According to another aspect, what is proposed is a method for controlling an opening element of a motor vehicle, comprising the processing method presented above, wherein said target is a limb of a user of the vehicle producing a gesture, said control method furthermore comprising the following step:

Commanding locking or unlocking of the opening element, and/or respectively opening or closing of the opening element, and/or respectively switching of a handle flush with the opening element from a rest position to a gripping position when the gesture is identified as being intentional.

The ability to command actions such as opening or closing an opening element, depending on the identified class of gesture, offers more intuitive and secure interaction with the vehicle. This makes it possible to improve user experience by adapting the responses of the vehicle to intentional gestures, while at the same time avoiding unwanted activations.

According to another aspect, what is proposed is a computer intended to be installed in a motor vehicle, comprising at least one processor and at least one memory, configured to implement each of the steps of the methods described above.

According to another aspect, what is proposed is a system for managing an opening element of a motor vehicle intended to be installed in said motor vehicle, comprising:
at least one transceiver intended to transmit an outward signal and to receive a return signal, and
an electronic management module comprising a computer as described above.

According to another aspect, what is proposed is a motor vehicle comprising a system for managing an opening element as described above.

### BRIEF DESCRIPTION OF THE DRAWINGS

Other features, details and advantages will emerge upon reading the following detailed description and from examining the appended drawings, in which:

FIG. 1 is a schematic view of a motor vehicle according to one embodiment of the present document.

FIG. 2 is a block diagram of a method for managing the opening of an opening element of a motor vehicle according to one embodiment of the present document.

FIG. 3 is a view, along a horizontal cutting plane, of a rear bumper of the motor vehicle of FIG. 1, with one example of transmission of a pulsed radiofrequency signal.

FIG. 4 is a block diagram showing the layers of a convolutional neural network able to be used as a classifier in the method for managing the opening of an opening element of a motor vehicle according to one embodiment of the present document.

### DETAILED DESCRIPTION OF EMBODIMENTS

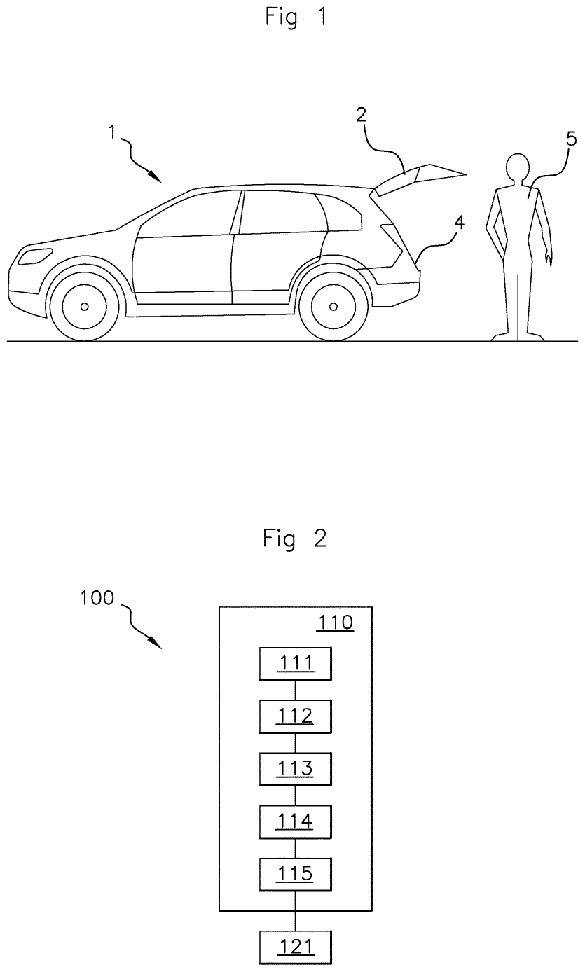

FIG. 1 schematically shows a motor vehicle 1 comprising a movable opening element 2 capable of being controlled by a management system for managing said opening element 2. A user 5 of the vehicle 1 is in the vicinity of the vehicle 1.

In the example illustrated, the opening element 2 is the rear trunk of the motor vehicle 1. According to one alternative, the opening element 2 could be a door.

Said management system comprises at least one transceiver arranged for example in a rear portion of the motor vehicle 1 (here the rear bumper 4), and an electronic management module comprising a computer.

The computer comprises at least one processor and one memory, and is configured to implement each of the steps of a method for controlling the opening element 2. The computer is capable of generating an output signal used to control the opening element 2.

A method 100 for controlling the opening element 2 according to one embodiment of the present document will be described below with reference to FIG. 2.

In particular, the method 100 for controlling the opening element 2 comprises a method 110 for detecting gestures based on a pulsed radiofrequency signal arising from a reflection from a moving target (steps 111 to 115).

A pulsed radiofrequency signal, referred to as an outward signal, may have been transmitted using a transceiver, for example positioned at the rear of a motor vehicle such as the vehicle 1. For example, the pulsed radiofrequency signal may be an ultra-wideband (UWB) signal.

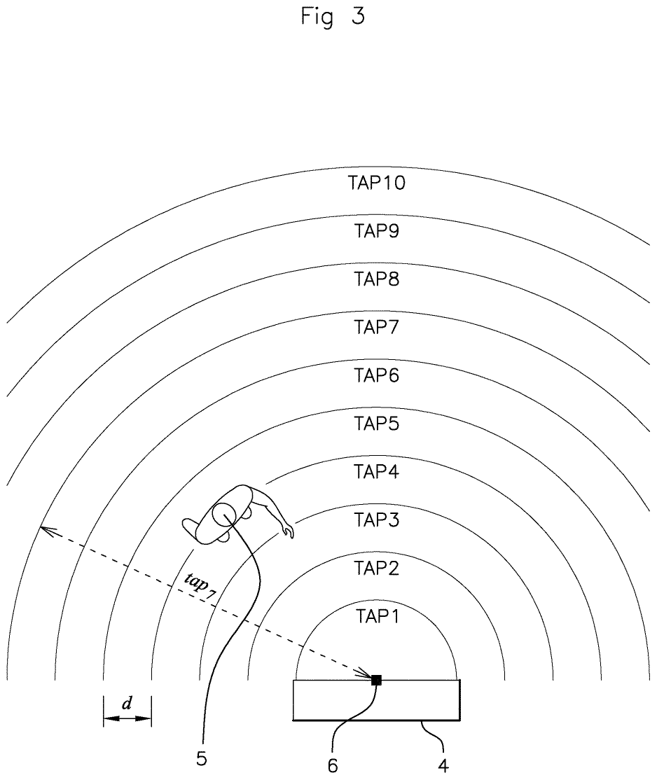

One example of this transmission of the outward signal is shown in FIG. 3, which illustrates, in a horizontal cutting plane (that is to say parallel to the ground on which the wheels of the motor vehicle 1 rest), the rear bumper 4 and the transceiver 6, which may be positioned at the center of the rear bumper 4.

During operation, the transceiver 6 transmits a uniform outward signal in all directions (equivalent to a circular signal in the horizontal plane).

As it propagates, the outward signal may be illustrated in the form of multiple circles TAP1, TAP2, TAP3, TAP4, TAP5, TAP6, TAP7, TAP8, TAP9, TAP10 with a center corresponding to the position of the transceiver 6 and a radius defined by the associated tapₖ (that is to say the distance from the position of the transceiver 6). A tap corresponds to a distance d and represents the distance between two successive circles. Thus, tapₖ is the radius of the circle TAPk and has the value d*k.

The user 5 of the vehicle may perform a gesture close to the vehicle 1, for example while placed on the circle TAP4 according to this example.

Through reflection from the moving target, for example a part of the body of a user 5 of the vehicle 1, a second pulsed radiofrequency signal, referred to as the return signal, is generated. This return signal may be received by a transceiver, for example the transceiver of the management system for managing the opening element 2 of the vehicle 1.

In a step 111, an input datum is obtained, chosen from at least one of the following types: an in-phase component I, a quadrature component Q, a phase and a derivative of the phase, corresponding to at least a portion of the return signal resulting from a reflection from the target at a distance tapₖ. With reference to the example shown in FIG. 3, it is possible for example to obtain the in-phase component and the phase of the return signal portions resulting from a reflection at a distance tap₁ to tap₈ (that is to say at the circles TAP1 to TAP8).

This step may comprise obtaining a sequence of points obtained during a time interval, said points being representative of the evolution of said input datum during the time interval. For example, the input data may comprise 400 points, representing the evolution of the signal over 800 ms.

In an optional step 112, the input data are normalized and/or the input data are standardized. Normalization consists in scaling the data so that they are within a specific range, generally between 0 and 1 or between −1 and 1. Standardization consists in transforming the data so that they have a mean of 0 and a standard deviation of 1.

In an optional step 113, the input data are centered. Centering consists in identifying a reference point in the data sequence, such as the maximum of an amplitude or a change in direction, and in aligning this point with the center of the sequence. For example, the phase maximum of the signal may be identified as the central point of the gesture. Indeed, in the case of a kick, this point represents the change in direction at the apex of the kick.

In an optional step 114, the length of the input data is equalized. A desired length, for example 400 points, may be predefined, and the length of the data may be equalized by padding or truncation. Padding consists in adding values (generally zeros) to the end or start of shorter sequences so as to bring them to the predefined length. Truncation consists in cutting longer sequences so as to bring them to the predefined length. Preferably, this step is carried out after a step 113 of centering the data.

In a step 115, based on said input datum and using a classifier, a classification of the gesture is determined according to the intentional or unintentional nature of the gesture. Intentional gestures are deliberate movements made by a user with the aim of triggering a specific action, such as for example opening the trunk of a vehicle by kicking under the rear bumper. On the contrary, unintentional gestures are accidental or unintentional movements, such as those caused by animals or passersby, which must not cause said specific action.

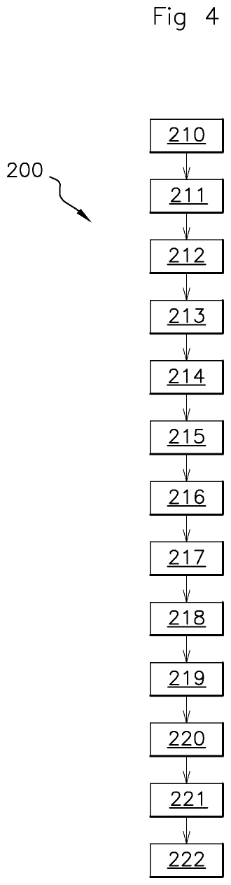

The classifier may be a convolutional neural network. One example of a convolutional neural network 200 able to be used is described with reference to FIG. 4. FIG. 4 gives a representation of the layers making up the convolutional neural network 200.

In this example, the input datum 210 may have a size (400, 12), the first dimension representing the length of the timeseries (for example a subsampling of a sequence of points obtained during a determined period, for example 800 ms) and the second dimension representing the number of portions of the return signal that are used (for example the in-phase component and the phase of portions of the signal resulting from a reflection of the outward signal at 6 different distances tap₁ . . . tap₆ from the transceiver).

In this example, the layers and parameters that are used are:
a first convolutional layer 211, characterized by the parameters:
   Number of filters=48,
   Size of the kernel of each filter=4,
   Convolution pitch=3.

The output dimension in this example is (134, 48).
a first ReLU activation layer 212. The output dimension in this example is (134, 48).
a first pooling layer 213, for example max-pooling layer, characterized by the parameters:
   kernel size=8
   pitch=9

The output dimension in this example is (16, 48).
A second convolutional layer 214, characterized by the parameters:
   Number of filters=30,
   Size of the kernel of each filter=6,
   Convolution pitch=2.

The output dimension in this example is (8, 30).
a second ReLU activation layer 215. The output dimension in this example is (8, 30).
a second pooling layer 216, for example max-pooling layer, characterized by the parameters:
   kernel size=2
   pitch=3

The output dimension in this example is (2, 30).
a flatten layer 217. The output dimension is (60).
A first fully connected layer 218, comprising 11 neurons. The output dimension in this example is (11).
a third ReLU activation layer 219. The output dimension in this example is (11).
A second fully connected layer 220, comprising 1 neuron. The output dimension in this example is (1).
a sigmoid activation layer 221. The output dimension in this example is (1).

The output 222 is a value between 0 and 1 representing a probability, adapted to binary classification tasks. The gesture may thus then be classified as being unintentional if the result is less than a predetermined threshold (for example 0.5), and as intentional otherwise.

In a step 121, with reference to FIG. 2, locking or unlocking of the opening element 2, and/or respectively opening or closing of the opening element 2, and/or respectively switching of a handle flush with the opening element 2 from a rest position to a gripping position are/is commanded when the gesture is identified as being intentional.

What is claimed is:

1. A method for detecting gestures based on a pulsed radiofrequency signal arising from a reflection from a moving target, comprising:
obtaining an input datum chosen from at least one of the following types: an in-phase component I of the signal, a quadrature component Q of the signal, a phase of the signal and a derivative of the phase of the signal, corresponding to at least a portion of the signal resulting from a reflection from the target at a distance tapₖ; and
determining, based on said input datum and using a classifier, a classification of the gesture according to the intentional or unintentional nature of the gesture;
wherein the classifier is a convolutional neural network comprising at least two convolutional layers, a non-linear activation function, a pooling layer, a flatten layer and in that the input data are “int8”-quantized by signed integers.

2. The method as claimed in claim 1, wherein the convolutional neural network comprises two fully connected layers that are used to combine features extracted by the flatten layer in order to classify the gesture.

3. The method as claimed in claim 1, further comprising:
a step of normalizing the input data or standardizing the input data, before determining, based on said input datum and using a classifier, a classification of the gesture according to the intentional or unintentional nature of the gesture.

4. The method as claimed in claim 1, further comprising:
a step of centering the input data, before determining, based on said input datum and using a classifier, a classification of the gesture according to the intentional or unintentional nature of the gesture.

5. The method as claimed in claim 4, further comprising:
a step of equalizing the length of the input data after the centering step.

6. The method as claimed in claim 1, wherein obtaining the input datum comprises obtaining a sequence of points obtained during a time interval, said points being representative of the evolution of said input datum during the time interval.

7. The method as claimed in claim 1, wherein said target is a part of a body of a user.

8. The method as claimed in claim 1, wherein the pulsed radiofrequency signal is an ultra-wideband (UWB) signal.

9. A computer installed in a motor vehicle, comprising:
at least one processor and at least one memory, configured to implement each of the steps of the method as claimed in claim 1.

10. A system for managing an opening element of the motor vehicle intended to be installed in the motor vehicle, comprising:
at least one transceiver configured to transmit an outward signal and to receive a return signal; and
an electronic management module comprising the computer as claimed in claim 9.

11. A motor vehicle comprising the system for managing the opening element of claim 10.

12. A method for controlling an opening element of a motor vehicle, comprising:
detecting gestures based on a pulsed radiofrequency signal arising from a reflection from a moving target, comprising:
obtaining an input datum chosen from at least one of the following types: an in-phase component I of the signal, a quadrature component Q of the signal, a phase of the signal and a derivative of the phase of the signal, corresponding to at least a portion of the signal resulting from a reflection from the target at a distance tapₖ; and
determining, based on said input datum and using a classifier, a classification of the gesture according to the intentional or unintentional nature of the gesture;
wherein the classifier is a convolutional neural network comprising at least two convolutional layers, a non-linear activation function, a pooling layer, a flatten layer and in that the input data are “int8”-quantized by signed integers;
wherein said target is a limb of a user of the vehicle producing a gesture, the control method further comprising:
commanding locking or unlocking of the opening element; or
respectively opening or closing of the opening element; or
respectively switching of a handle flush with the opening element from a rest position to a gripping position when the gesture is identified as being intentional.

13. The method as claimed in claim 12, wherein the convolutional neural network comprises two fully connected layers that are used to combine features extracted by the flatten layer in order to classify the gesture.

14. The method as claimed in claim 12, further comprising:
a step of normalizing the input data or standardizing the input data, before determining, based on said input datum and using a classifier, a classification of the gesture according to the intentional or unintentional nature of the gesture.

15. The method as claimed in claim 12, further comprising:
a step of centering the input data, before determining, based on said input datum and using a classifier, a classification of the gesture according to the intentional or unintentional nature of the gesture.

16. The method as claimed in claim 15, further comprising:
a step of equalizing the length of the input data after the centering step.

17. The method as claimed in claim 12, wherein obtaining the input datum comprises obtaining a sequence of points obtained during a time interval, said points being representative of the evolution of said input datum during the time interval.
